(19) United States
(12) Patent Application Publication
(10) Pub. No.: US 2019/0287566 A1
(43) Pub. Date: Sep. 19, 2019

(54) MAGNETIC DISK DEVICE AND REFRESH PROCESSING METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Ryuichi SATO, Kawasaki Kanagawa (JP)

(21) Appl. No.: 16/120,293

(22) Filed: Sep. 2, 2018

(30) Foreign Application Priority Data
Mar. 15, 2018 (JP) 2018-048492

(51) Int. Cl. G11B 19/04; G11B 5/012; G11B 5/02

(52) U.S. Cl. CPC G11B 19/045; G11B 5/02; G11B 5/012

(57) ABSTRACT

A magnetic disk device includes a disk with a plurality of data storage tracks, a head that writes data to the plurality of data storage tracks and reads data from the plurality of data storage tracks, and a controller. The controller is configured to circumferentially divide each of the plurality of data storage tracks into multiple count areas, for each count area in each of the plurality of data storage tracks, track a number of adjacent write counts; determine that a first number of adjacent write counts for a first count area in a first data storage track causes a refresh threshold value for the first count area to be exceeded, and in response to determining the refresh threshold value has been exceeded, rewrite data stored in the first data storage track.

### CROSS-REFERENCE TO RELATED APPLICATIONS

This application is based upon and claims the benefit of priority from Japanese Patent Application No. 2018-048492, filed Mar. 15, 2018, the entire contents of which are incorporated herein by reference.

### FIELD

Embodiments described herein relate generally to a magnetic disk device and a refresh processing method.

### BACKGROUND

In magnetic disk devices, when data is written, erasure of data may occur due to the influence (adjacent track interference, or ATI) of leakage flux from a magnetic head or the like. The ATI differs depending on, for example, characteristics of the head, a track per inch (TPI) setting value, a write current setting value, and other factors. To prevent side erase, magnetic disk devices have a function (such as a refresh function) for rewriting data stored in a particular track when the number of times that data is written to a track that is adjacent to the particular track reaches a specified number of times.

### DESCRIPTION OF THE DRAWINGS

FIG. 1 is a block diagram illustrating a configuration of a magnetic disk device according to an embodiment.

FIG. 2 is a schematic diagram illustrating an example of a count area.

FIG. 3 is a schematic diagram illustrating an example of a management table.

FIG. 4 is a schematic diagram illustrating another example of the management table.

FIG. 5 is a schematic diagram illustrating another example of the management table.

FIG. 6 is a flowchart illustrating an example of a refresh processing method according to the embodiment.

FIG. 7 is a schematic diagram illustrating an example of a management table according to Modified Embodiment 1.

FIG. 8 is a flowchart illustrating an example of a refresh processing method according to Modified Embodiment 2.

FIG. 9 is a flowchart illustrating an example of a refresh processing method according to Modified Embodiment 3.

FIG. 10 is a flowchart illustrating an example of a refresh processing method according to Modified Embodiment 4.

### DETAILED DESCRIPTION

Embodiments provide a magnetic disk device and a refresh processing method for improving reliability of data stored in the magnetic disk device.

In general, according to one embodiment, a magnetic disk device includes a disk with a plurality of data storage tracks, a head that writes data to the plurality of data storage tracks and reads data from the plurality of data storage tracks, and a controller. The controller is configured to circumferentially divide each of the plurality of data storage tracks into multiple count areas, for each count area in each of the plurality of data storage tracks, track a number of adjacent write counts, determine that a first number of adjacent write counts for a first count area in a first data storage track causes a refresh threshold value for the first count area to be exceeded, and in response to determining the refresh threshold value has been exceeded, rewrite data stored in the first data storage track.

Hereinafter, embodiments will be described with reference to the accompanying drawings. The drawings are merely examples and do not limit the scope of the prevent disclosure.

### Embodiment

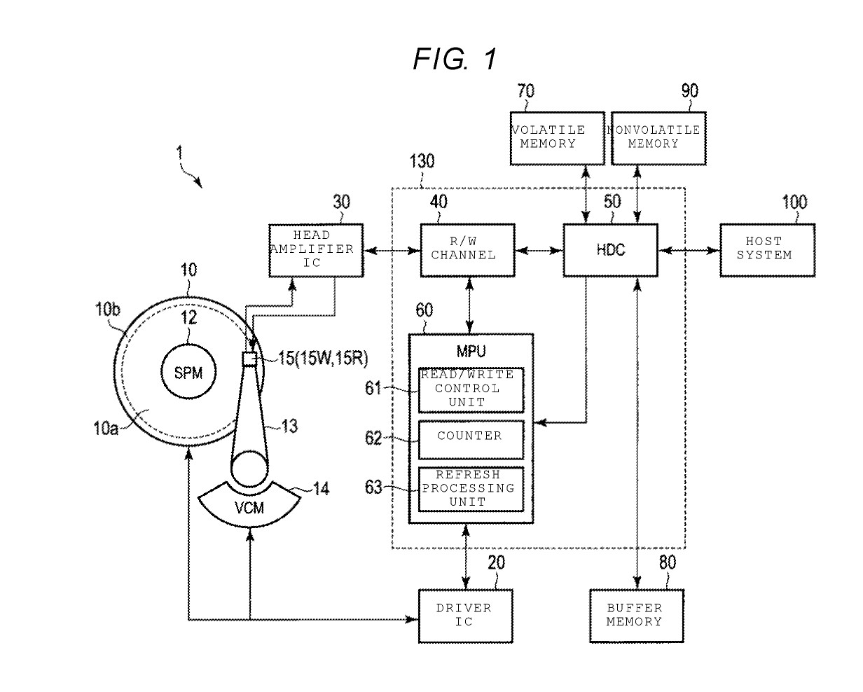

FIG. 1 is a block diagram illustrating a configuration of a magnetic disk device 1 according to a first embodiment.

The magnetic disk device 1 includes a head disk assembly (HDA), a driver IC 20, a head amplifier integrated circuit (hereinafter, referred to as a head amplifier IC or preamplifier) 30, a volatile memory 70, a buffer memory (buffer) 80, a nonvolatile memory 90, and a system controller 130 which is an integrated circuit of one chip, which will be described later. The magnetic disk device 1 is connected to a host system (hereinafter, simply referred to as a host) 100.

The HDA includes a magnetic disk (hereinafter, referred to as a disk) 10, a spindle motor (hereinafter, referred to as an SPM) 12, an arm 13 on which a head 15 is mounted, and a voice coil motor (hereinafter, referred to as a VCM) 14. The disk 10 is attached to the spindle motor 12 and rotates by driving the spindle motor 12. The arm 13 and the VCM 14 constitute an actuator. The actuator controls movement of the head 15 mounted on the arm 13 to a target position on the disk 10 by driving the VCM 14. The magnetic disk device 1 may include two or more of the disk 10 and the head 15.

Writable areas of the disk 10 include a user data area 10a that can be used by a user and a system area 10b for writing information necessary for system management. Hereinafter, a direction orthogonal to the radial direction of the disk 10 is referred to as a circumferential direction.

The head 15 includes a write head 15W and a read head 15R mounted on a slider as a main body. The write head 15W writes data onto the disk 10. The read head 15R reads data recorded in a data track on the disk 10.

A driver IC 20 controls driving of the SPM 12 and the VCM 14 based on signals from a system controller 130 (more specifically, an MPU 60 described later).

A head amplifier IC (preamplifier) 30 includes a read amplifier and a write driver. The read amplifier amplifies a read signal read from the disk 10 and outputs the read signal to a system controller 130 (specifically, a read/write (R/W) channel 40 described later). The write driver outputs a write current corresponding to a signal output from the R/W channel 40 to the head 15.

The volatile memory 70 is a semiconductor memory in which stored data is lost when power thereto is cut off. The volatile memory 70 stores data and the like necessary for processing in each component of the magnetic disk device 1. The volatile memory 70 is, for example, a dynamic random access memory (DRAM) or a synchronous dynamic random access memory (SDRAM).

A buffer memory 80 is a semiconductor memory that temporarily records data and the like communicated between the magnetic disk device 1 and a host 100. The buffer memory 80 may be formed integrally with the volatile memory 70. The buffer memory 80 is, for example, a DRAM, a static random access memory (SRAM), the SDRAM, a ferroelectric random access memory (FeRAM), a magnetoresistive random access memory (MRAM), or the like.

The nonvolatile memory 90 is a semiconductor memory used for storing data stored even when power supply is cut off. The nonvolatile memory 90 is, for example, a NOR type or NAND type flash ROM (read only memory) (FROM).

The system controller 130 (controller) is implemented by using a large scale integrated circuit (LSI), called a System-on-a-Chip (SoC), in which a plurality of elements are integrated on a single chip, for example. The system controller 130 includes a read/write (R/W) channel 40, a hard disk controller (HDC) 50, and a microprocessor (MPU) 60. The system controller 130 is electrically connected to the driver IC 20, the head amplifier IC 30, the volatile memory 70, the buffer memory 80, the nonvolatile memory 90, and the host system 100.

The R/W channel 40 executes signal processing of read data transferred from the disk 10 to the host 100 and write data transferred from the host 100 according to the instruction from the MPU 60 described later. The R/W channel 40 has a circuit or a function for measuring signal quality of read data. The R/W channel 40 is electrically connected to the head amplifier IC 30, the HDC 50, the MPU 60, and the like, for example.

The HDC 50 controls data transfer between the host 100 and the R/W channel 40 according to instructions from the MPU 60, which is to be described later. The HDC 50 is electrically connected to, for example, the R/W channel 40, the MPU 60, the volatile memory 70, the buffer memory 80, the nonvolatile memory 90, and the like.

The MPU 60 is a main controller that controls each component of the magnetic disk device 1. The MPU 60 controls the VCM 14 via the driver IC 20 and executes servo control for positioning the head 15. The MPU 60 controls a write operation of data to the disk 10 and selects a save destination (or “write location”) of write data. The MPU 60 controls a read operation of data from the disk 10 and controls processing of read data to the host 100. The MPU 60 is connected to each component of the magnetic disk device 1, as shown. The MPU 60 is electrically connected to the driver IC 20, the R/W channel 40, and the HDC 50, and for example.

The MPU 60 includes a read/write control unit 61, a counter 62, and a refresh processing unit 63. The MPU 60 executes operation of these components, for example, the read/write control unit 61, the counter 62, and the refresh processing unit 63, and the like, on firmware in some embodiments. The MPU 60 may include these components as circuits.

The read/write control unit 61 controls data read processing and data write processing according to one or more commands from the host 100. The read/write control unit 61 controls the VCM 14 via the driver IC 20, positions the head 15 at a target position on the disk 10, and reads or writes data.

The counter 62 counts the number of times (hereinafter, referred to as the number of counts or the number of writes) data is written to an area adjacent in the radial direction (hereinafter, referred to as an adjacent area). The counter 62 divides the disk 10 into a plurality of recording areas arranged in the radial direction, for example, a plurality of tracks. The counter 62 further divides the plurality of tracks into a plurality of areas CR in the circumferential direction (hereinafter, referred to as count areas or divided areas). One count area CR includes, for example, at least one sector of the disk 10. In one example, one count area CR is an area larger than a sector. The counter 62 counts the number of counts (e.g., adjacent write counts) for each count area in each track, for example. Specifically, the counter 62 increments the number of counts for a particular count area of a particular track when data is written in an area radially proximate to the particular count area. For example, count areas that are radially proximate to the particular count area can include a count area of a different track that is radially adjacent to and contiguous with the particular count area, and a count area of a different track that is proximate the particular count area in the radial direction, but is not directly in contact with the particular count area, such as a count area that is two or more tracks removed from the particular track. While the counter 62 counts the number of counts for a particular count area when data is written in an area adjacent to the particular count area in the radial direction, in some embodiments, the counter 62 may also count the number of counts when data is written to an area farther in the radial direction from the particular count area than an adjacent area in the radial direction.

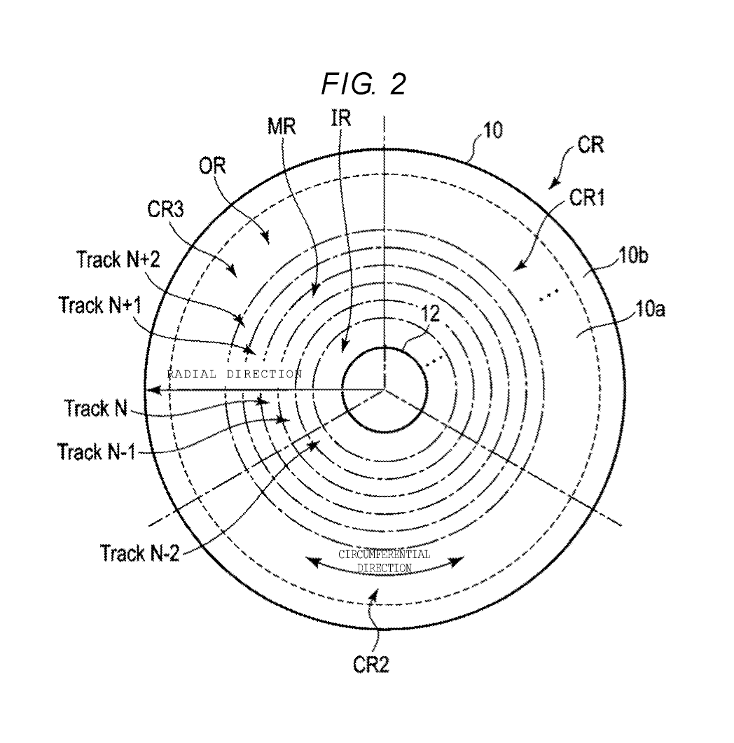

FIG. 2 is a schematic diagram illustrating an example of the count area CR. Hereinafter, with respect to the radial direction, a direction from the center of the disk 10 to the outside periphery of the disk 10 (i.e., the direction in which the tip of the arrow in the radial direction in FIG. 2 is directed) is referred to as an outer diameter direction and the direction opposite to the outer diameter direction is referred to as an inner diameter direction. In the disk 10, an area positioned on the outer diameter region is referred to as an outer radial area OR, an area positioned on the inner diameter region is referred to as an inner radial area IR, and an area positioned between the outer radial area OR and the inner radial area IR is referred to as an intermediate radial area MR. In FIG. 2, illustrated tracks include Track N−2, Track N−1, Track N, Track N+1 and Track N+2, which are aligned consecutively from the inner diameter region toward the outer diameter region.

In the example illustrated in FIG. 2, the counter 62 divides the disk 10, for example, the user data area 10a, into count areas CR1, CR2, and CR3 in the circumferential direction. That is, the counter 62 divides each of Track N−2 to Track N+2 into count areas CR1 to CR3. When data is written in the count area CR1 of Track N, the counter 62 counts the number of counts of the count area CR1 of Track N+1 and Track N−1. The counter 62 may divide the disk 10 into a number of count areas other than three count areas in a circumferential direction, for example, into two count areas CR or four count areas CR, depending on a capacity of a memory, (for example, the capacity of the nonvolatile memory 90).

The counter 62 holds the number of counts for each count area CR of each track. Each time data is written to the adjacent area of the count area CR of a predetermined track, the counter 62 adds a predetermined value (hereinafter, referred to as an addition value), for example 1, to the number of counts corresponding to the count area CR. The counter 62 holds or stores at least one threshold value (hereinafter, referred to as a refresh threshold value) for executing a process (hereinafter, referred to as a refresh process) for rewriting the read data to the predetermined recording area. For example, in some embodiments, the counter 62 holds or stores the refresh threshold value for each track. In some embodiments, the counter 62 may also hold or store the refresh threshold value for each count area of each track. In one example, the refresh threshold values of the track positioned in the inner radial area IR and the track positioned in the outer radial area OR are less than the refresh threshold value of the track positioned in the intermediate radial area MR. The refresh threshold value includes, for example, a threshold value with respect to a value which is the largest (hereinafter, simply referred to as a maximum value) of a plurality of numbers of counts respectively corresponding to a plurality of count areas CR of a particular track, a threshold value with respect to a difference value between the maximum value and a value which is the smallest (hereinafter, simply referred to as the minimum value) of a plurality of numbers of counts respectively corresponding to the plurality of count areas CR of the particular track, and a threshold value with respect to a difference value between the maximum value of a particular track and the maximum value of a track adjacent to the particular track in the radial direction (hereinafter, simply referred to as an adjacent track). Hereinafter, the “difference value between the maximum value and the minimum value” is referred to as an “intra-track difference value” and the “difference value between the maximum value of a particular track and the maximum value of an adjacent track of the particular track” is referred to as an “inter-track difference value”. Also, the “threshold value with respect to the maximum value” is referred to as a “count threshold value”, the “threshold value with respect to the intra-track difference value” is referred to as an “intra-track threshold value”, and the “threshold value with respect to the inter-track difference value” is referred to as an “inter-track threshold value”. The counter 62 measures the maximum value and the minimum value of each track at a predetermined time, for example, when the magnetic disk device 1 is idling, and/or immediately after adding the addition value to the number of counts for a specific count area CR. The counter 62 determines whether the maximum value, the intra-track difference value, and/or the inter-track difference value is either greater than the refresh threshold value or equal to or less than the refresh threshold value. The counter 62 may hold the maximum value or the minimum value of each track. Alternatively or additionally, the counter 62 can or record the maximum value or minimum value of each track via a table in the memory, for example, the nonvolatile memory 90. When it is determined that the maximum value, the intra-track difference value, or the inter-track difference value is greater than the refresh threshold value, the counter 62 outputs a signal (hereinafter, referred to as a refresh signal) for executing a refresh process to the refresh processing unit 63. Upon completion of the refresh process being performed on a particular track, the counter 62 may change a plurality of counts that respectively correspond to the each of the plurality of count areas CR of the particular track on which the refresh process is executed. The counter changes such counts to a value that reflects that data has not been written in an area adjacent to the particular track, for example, 0. The counter 62 may determine, in any order, whether the maximum value, intra-track difference value, and/or inter-track difference value are greater than the refresh threshold value or equal to or less than the refresh threshold value. For example, in some embodiments, the counter 62 may first determine whether the maximum value is greater than the count threshold value or equal to or less than the count threshold value. Alternatively, in some embodiments, the counter 62 may first determine whether the intra-track difference value is greater than the intra-track difference threshold value or equal to or less than the intra-track difference threshold value. Alternatively, in some embodiments, the counter 62 may first determine whether the inter-track difference value is greater than the inter-track difference threshold value or equal to or less than the inter-track difference threshold value. Alternatively, in some embodiments the counter 62 may determine, for only one of the maximum value, the intra-track difference value, and the inter-track difference value, whether such a value is greater than the refresh threshold value or equal to or less than the refresh threshold value. Alternatively, in some embodiments, when the counter determines that all of the maximum value, intra-track difference value, and inter-track difference value are greater than the refresh threshold value, the counter 62 may output the refresh signal to the refresh processing unit 63.

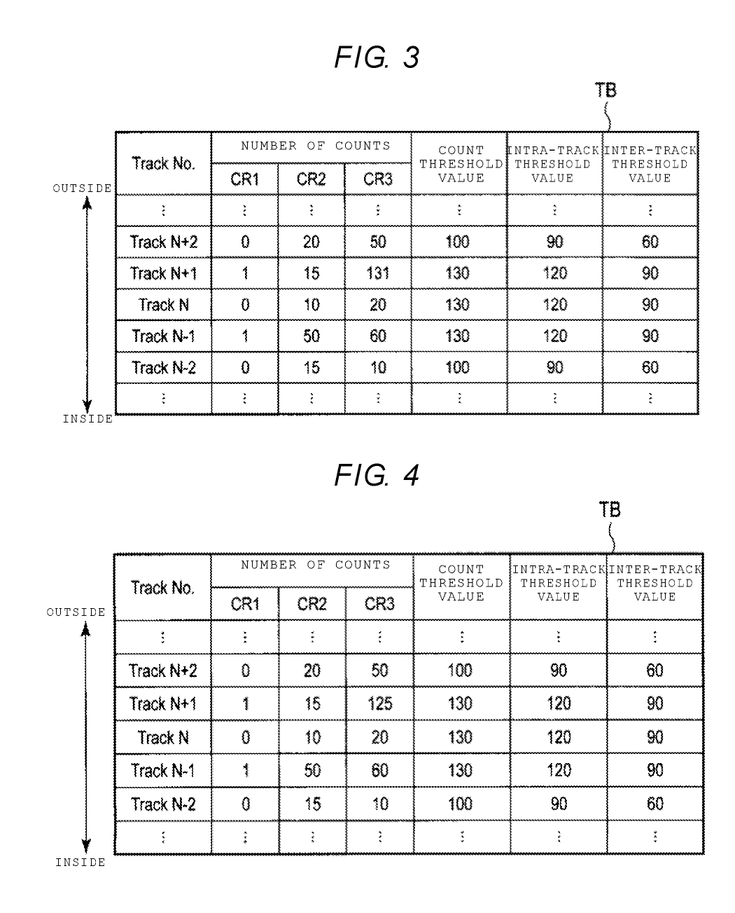

The counter 62 manages, for example, the number of counts, the refresh threshold value, and the like for each count area CR of each track by a table (hereinafter, referred to as management table) TB (shown in FIG. 3) or the like. The counter 62 records the management table TB in a memory, for example, the nonvolatile memory 90, the system area 10b, or the like. The counter 62 may manage the number of counts, the refresh threshold value, and the like, for each count area CR of each track, as data. The counter 62 may record data such as the number of counts, the refresh threshold value, and the like for each count area CR of each track in a memory, for example, the nonvolatile memory 90, the system area 10b, and the like, respectively.

FIGS. 3 to 5 are schematic diagrams illustrating an example of the management table TB. In FIGS. 3 to 5, the management table TB includes the number of counts of the count areas CR1, CR2, and CR3 in each track, the count threshold value of each track, the intra-track threshold value of each track, and the inter-track threshold value of each track. In FIGS. 3 to 5, the intra-track threshold value is less than the count threshold value. The inter-track threshold value is less than the count threshold value and the intra-track threshold value.

In FIGS. 3 to 5, the count threshold value, the in-track threshold value, and the inter-track threshold value are different, but may be the same. Also, the intra-track threshold value may be greater than the count threshold value, and the inter-track threshold value may be greater than both the count threshold value and the intra-track threshold value. In FIGS. 3 to 5, the count threshold values, intra-track threshold values, and inter-track threshold values of Track N−2 to Track N+2 may be different or may be the same.

In the example illustrated in FIG. 3, when data is written to the count area CR1 of Track N, the counter 62 adds 1, as an addition value, to the number of counts (1) of the count area CR1 of Track N+1, and therefore sets the number of counts of the count area CR1 of Track N+1 to two in the management table TB. The counter 62 adds 1, as an addition value, to the number of counts (1) of the count area CR1 of Track N−1, and therefore sets the number of counts of the count area CR1 of Track N−1 to two.

After the counter 62 adds the addition value to the number of counts of the count area CR1 of Track N+1 and the number of counts of the count area CR1 of Track N−1, the counter 62 then measures the maximum values and the minimum values of Tracks N−2 to N+2, respectively. The counter 62 determines whether the maximum values of Tracks N−2 to N+2 are greater than or equal to or less than the count threshold value corresponding to each of Tracks N−2 to N+2, respectively.

In the example illustrated in FIG. 3, the counter 62 determines, from the management table TB, that the maximum value (131) of Track N+1 is greater than the count threshold value (130) and outputs the refresh signal for executing the refresh process on Track N+1 to the refresh processing unit 63.

In the example illustrated in FIG. 4, the counter 62 determines, from the management table TB, that the maximum value (125) of Track N+1 is equal to or less than the count threshold value (130), and measures the maximum value (125) and the minimum value (1) of Track N+1. The counter 62 calculates an intra-track difference value (124) between the maximum value (125) and the minimum value (1) and determines whether the intra-track difference value (124) is greater than the intra-track threshold value (120) or equal to or less than the intra-track threshold value (120), in the management table TB. The counter 62 determines that the intra-track difference value (124) is greater than the intra-track threshold value (120), and outputs to the refresh processing unit 63 the refresh signal for executing the refresh process on Track N+1.

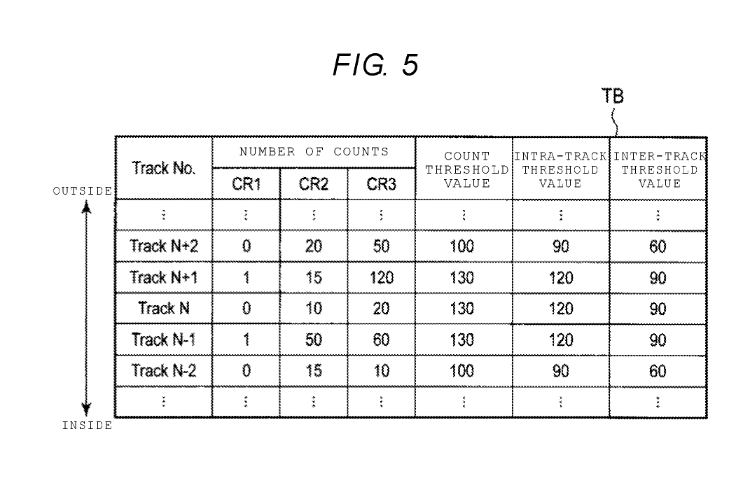

In the example illustrated in FIG. 5, the counter 62 determines from the management table TB that the maximum value (120) of Track N+1 is equal to or less than the count threshold value (130) and measures the maximum value (120) and minimum value (1) of Track N+1. The counter 62 calculates an intra-track difference value (119) between the maximum value (120) and the minimum value (1) and determines whether the intra-track difference value (119) is greater than the intra-track threshold value (120) or equal to or less than the intra-track threshold value (120). Thus, the counter 62 determines that the intra-track difference value (119) is equal to or less than the intra-track threshold value (120). The counter 62 then measures the maximum value (50) of Track N+2 adjacent to Track N+1 and the maximum value (20) of Track N adjacent to Track N+1. The counter 62 calculates the inter-track difference value (70) between the maximum value of Track N+1 (120) and the maximum value (50) of Track N+2, and the inter-track difference value (100) between the maximum value of Track N+1 (120) and the maximum value of Track N (20), respectively. The counter 62 determines whether the inter-track difference value (70) is greater than the inter-track threshold value (90) or equal to or less than the inter-track threshold value (90). Thus, the counter 62 determines that the inter-track difference value (70) is equal to or less than the inter-track threshold value (90). The counter 62 also determines whether the inter-track difference value (100) is greater than the inter-track threshold value (90) or equal to or less than the inter-track threshold value (90). Thus, the counter 62 determines that the inter-track difference value (100) is greater than the inter-track threshold value (90) and outputs the refresh signal for executing the refresh process on Track N+1 to the refresh processing unit 63.

For example, when the refresh process is executed on Track N+1, the counter 62 sets the number of counts of the count areas CR1, CR2, and CR3 of Track N+1 to 0 (zero).

The refresh processing unit 63 executing a refresh process is now described. For example, the refresh processing unit 63 executes the refresh process when the refresh signal is received from the counter 62. When the refresh process is executed, the refresh processing unit 63 outputs, for example, a signal to the counter 62 indicating that the refresh process is completed.

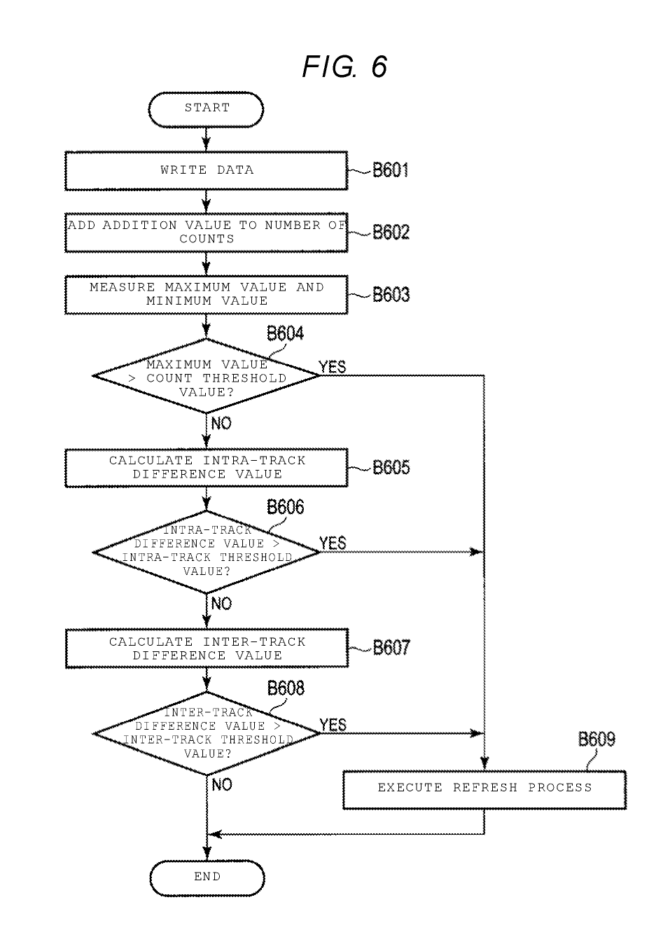

FIG. 6 is a flowchart illustrating an example of a refresh processing method according to the embodiment.

The MPU 60 writes data into a particular count area CR of a track (hereinafter, referred to as a target track) which becomes a target of the disk 10 (B601). The MPU 60 adds the addition value to the number of counts of the particular count area CR of each of the adjacent tracks on both sides in the radial direction of the target track (B602). The MPU 60 measures the maximum value and the minimum value of each track (B603) and determines whether or not the maximum value of each track is greater than the count threshold value or equal to or less than the count threshold value (B604) for that track. When it is determined that the maximum value of the particular track is greater than the count threshold value (YES in B604), the MPU 60 proceeds to the process in B609. When it is determined that the maximum value of the particular track is equal to or less than the count threshold value (NO in B604), the MPU 60 calculates the intra-track difference value corresponding to the particular track (B605).

The MPU 60 determines whether the intra-track difference value corresponding to the particular track is greater than the intra-track threshold value of the adjacent track on the outer diameter direction side of the particular track or equal to or less than the intra-track threshold value of the adjacent track on the outer diameter direction side of the particular track. In addition, the MPU 60 determines whether the intra-tack difference value corresponding to the particular track is greater than the intra-track threshold value of the adjacent track on the inner diameter direction side of the particular track or equal to or less than the intra-track threshold value of the adjacent track on the inner diameter direction side of the particular track (B606). When it is determined that the intra-track difference value corresponding to the particular track is greater than the intra-track threshold value of either the adjacent track on the inner diameter direction side or the adjacent track on the outer diameter direction side (YES in B606), the MPU 60 proceeds to the process in B609. When it is determined that the intra-track difference value corresponding to the particular track is equal to or less than the intra-track threshold value of both of the adjacent tracks (NO in B606), the MPU 60 calculates the inter-track difference value corresponding to the particular track and the adjacent track on the inner diameter direction side of the particular track and the adjacent track on the outer diameter direction side of the particular track (B607). For example, the MPU 60 calculates an inter-track difference value (hereinafter, referred to as an inner inter-track difference value) between a maximum value of the particular track and a maximum value of the adjacent track on the inner diameter direction side of the particular track. The MPU also calculates an inter-track difference value (hereinafter, referred to as an outer inter-track difference value) between the maximum value of the particular track and a maximum value of the adjacent track on the outer diameter direction side of the particular track.

The MPU 60 determines whether either of the above-described inter-track difference values corresponding to the particular track is greater than the inter-track threshold value or equal to or less than the inter-track threshold value (B608). That is, the MPU 60 determines whether either of the inner inter-track difference value or the outer inter-track difference value is greater than the inter-track threshold value or equal to or less than the inter-track threshold value for the particular track. When it is determined that both of the above-described inter-track difference values corresponding to the particular track are equal to or less than the inter-track threshold value (NO in B608), the MPU 60 ends the process. When it is determined that at least one of the above-described inter-track difference values corresponding to the particular track is greater than the inter-track threshold value (YES in B608), the MPU 60 executes a refresh process on the particular track (B609), and ends the process. For example, when it is determined that both the inner inter-track difference value and the outer inter-track difference value corresponding to the particular track are equal to or less than the inter-track threshold value, the MPU 60 ends the process. When it is determined that at least one of the inside inter-track difference value and the outside inter-track difference value that correspond to the particular track is greater than the inter-track threshold value, the MPU 60 executes the refresh process on the particular track.

According to the embodiment, the magnetic disk device 1 circumferentially divides a plurality of recording areas (such as tracks) into a plurality of count areas CR. The magnetic disk device 1 tracks and/or stores the number of counts for each count area CR of each track. Further, for each track, the magnetic disk device 1 tracks the count threshold value, the intra-track threshold value, the inter-track threshold value, and the like, as the refresh threshold value. The magnetic disk device 1 measures the maximum value and the minimum value of each track and determines whether the maximum value of each track is greater than the count threshold value, or equal to or less than the count threshold value. When it is determined that the maximum value of the predetermined track is greater than the count threshold value, the magnetic disk device 1 executes the refresh process on the predetermined track. When it is determined that the intra-track difference value corresponding to the predetermined track (for either of the radially adjacent tracks) is greater than the intra-track threshold value, the magnetic disk device 1 executes the refresh process on the predetermined track. When it is determined that the inter-track difference value corresponding to the predetermined track (for either of the radially adjacent tracks) is greater than the inter-track threshold value, the magnetic disk device 1 executes the refresh process on the predetermined track. For that reason, the magnetic disk device 1 can detect that a concentrated write process radially proximate to a specific circumferential portion of a particular recording area (i.e., of a particular track). In response, the magnetic disk executes the refresh process on the particular recording area, including the specific circumferential portion near which the concentrated write process has been performed. That is, the magnetic disk device 1 can prevent data from becoming unreadable due to adjacent track interference (ATI). Accordingly, the reliability of data storage in the magnetic disk device 1 is improved.

Next, a magnetic disk device according to a modified embodiment will be described. In the modified embodiment, the same reference numerals are given to the similar elements of the embodiment described above, and a detailed description thereof will be omitted.

### Modified Embodiment 1

The magnetic disk device 1 of modified embodiment 1 is different from the embodiment described above in that the refresh threshold value is held per a plurality of tracks.

For example, the counter 62 holds a refresh threshold value for specific predetermined ranges of tracks, which are divided in the radial direction. In the modified example, each predetermined range in the radial direction includes a plurality of tracks.

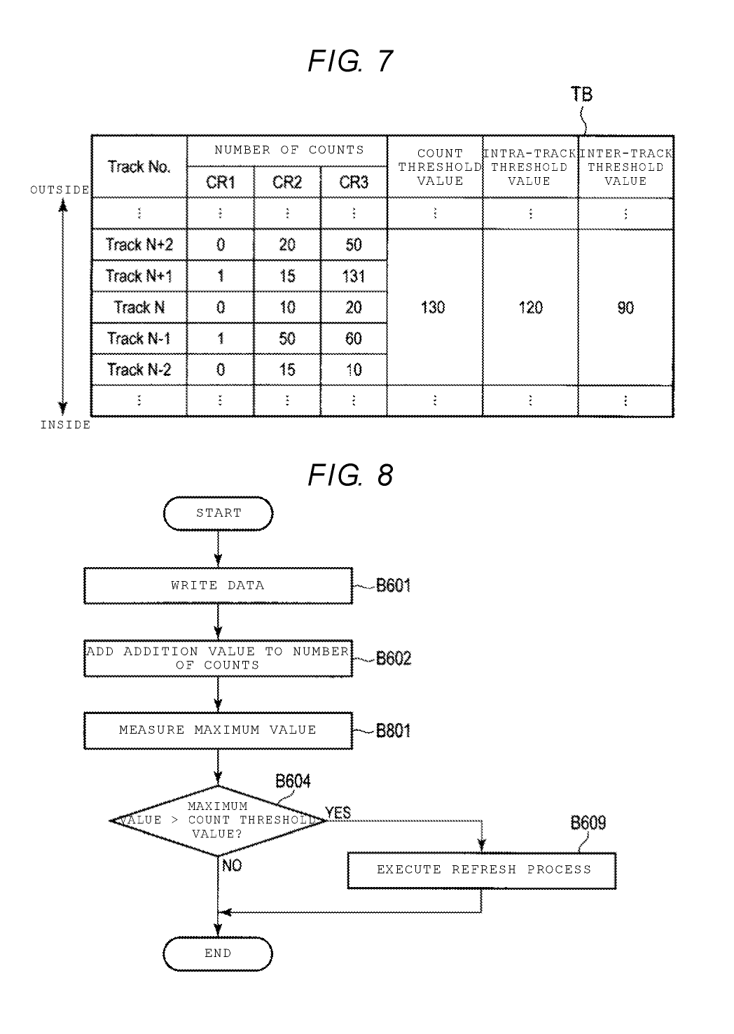

FIG. 7 is a schematic diagram illustrating an example of a management table TB according to modified embodiment 1. In FIG. 7, the management table TB includes the number of counts of the count areas CR1, CR2, and CR3 in each track, a count threshold value for each predetermined range in the radial direction, an intra-track threshold value for each predetermined range in the radial direction, and an inter-track threshold value for each predetermined range in the radial direction.

For example, when data is written to Track N, the counter 62 adds the addition value to the number of counts of the count area CR1 of Track N+1 and the number of counts of the count area CR1 of Track N−1, and then measures the maximum value and the minimum value of Tracks N−2 to N+2, respectively. The counter 62 determines whether the maximum value of any of Tracks N−2 to N+2 is greater than a common count threshold value in Tracks N−2 to N+2 or equal to or less than the common count threshold value, respectively.

According to modified embodiment 1, the magnetic disk device 1 holds the refresh threshold value for each predetermined range divided in the radial direction. Since there is no need to hold the refresh threshold value of each track, the magnetic disk device 1 can reduce the size of the management table TB to be recorded in the memory, for example, the nonvolatile memory 90 or the like.

### Modified Embodiment 2

The magnetic disk device 1 of Modification example 2 is different in the refresh process from the initial embodiment and the modified embodiment 1 described above.

FIG. 8 is a flowchart illustrating an example of a refresh processing method according to modified embodiment 2.

The MPU 60 writes data into a predetermined count area CR of the target track (B601), and adds the addition value to the number of counts of the predetermined count area CR of each of the adjacent tracks on the outer diameter direction side and the inner diameter direction side of the target track (B602). The MPU 60 measures the maximum value of each track (B801) and determines whether or not the maximum value of each track is greater than the count threshold value for that track or equal to or less than the count threshold value for that track (B604). When it is determined that the maximum value of a particular track is greater than the count threshold value for that particular track (YES in B604), the MPU 60 executes a refresh process on the predetermined track (B609) and ends the process. When it is determined that the maximum value of the particular track is equal to or less than the count threshold value for that particular track (NO in B604), the MPU 60 ends the process.

According to modified embodiment 2, the magnetic disk device 1 measures only the maximum value of each track. As a result, the magnetic disk device 1 can simplify the refresh process.

### Modified Embodiment 3

The magnetic disk device 1 of modified embodiment 3 is different in the refresh process from the initial embodiment and modified embodiments 1 and 2, described above.

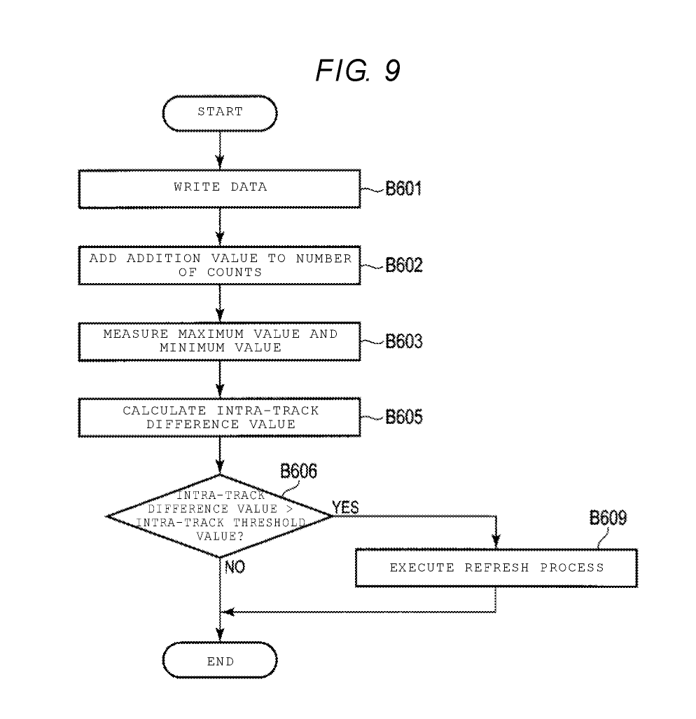

FIG. 9 is a flowchart illustrating an example of a refresh processing method according to modified embodiment 3.

The MPU 60 writes data into a particular count area CR of the target track (B601), and adds the addition value to the number of counts of the particular count area CR of each of the adjacent tracks on both sides of the target track (B602). The MPU 60 measures the maximum value and the minimum value of each track (B603) and calculates the intra-track difference value corresponding to each track (B605). The MPU 60 determines whether the intra-track difference value corresponding to each track is greater than the intra-track threshold value of that track or equal to or less than the intra-track threshold value of that track (B606). When it is determined that the intra-track difference value corresponding to the particular track is greater than the intra-track threshold value (YES in B606), the MPU 60 executes the refresh process on the particular track (B609), and ends the process. When it is determined that the intra-track difference value corresponding to the predetermined track is equal to or less than the intra-track threshold value (NO in B606), the MPU 60 ends the process.

According to modified example 3, the magnetic disk device 1 calculates the intra-track difference value corresponding to each track after the maximum value and the minimum value of each track are measured, and determines whether the intra-track difference value corresponding to each track is greater than the intra-track threshold value or equal to or less than the intra-track threshold value. For that reason, the magnetic disk device 1 can simplify the refresh process.

### Modified Example 4

The magnetic disk device 1 of Modification example 4 is different in the refresh process from the initial embodiment and from the modified embodiments 1-3 described above.

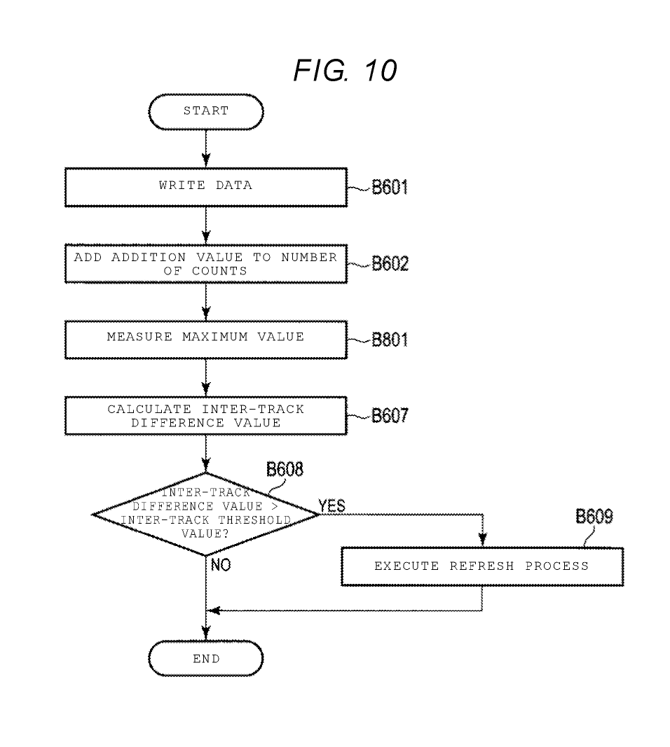

FIG. 10 is a flowchart illustrating an example of the refresh processing method according to modified embodiment 4.

The MPU 60 writes data into a particular count area CR of the target track (B601) and adds the addition value to the number of counts of the particular count area CR of each of the adjacent tracks on both sides of the target track (B602). The MPU 60 measures the maximum value of each target track (B801) and calculates the inter-track difference value associated with each of the adjacent tracks on the outer diameter direction side and the inner diameter direction side of the target track (B607). The MPU 60 determines whether the inter-track difference value for each of the tracks adjacent to the target track is greater than the inter-track threshold value for that adjacent track or equal to or less than the inter-track threshold value for that adjacent track (B608). In a case where it is determined that the inter-track difference value for either of the tracks adjacent to the target track is less than the inter-track threshold value for that adjacent track (NO in B608), the MPU 60 ends the process. When it is determined that the inter-track difference value corresponding to either of the tracks adjacent to the target track is greater than the inter-track threshold value for that adjacent track (YES in B608), the MPU 60 executes the refresh process on the target track (B609), and ends the process.

According to modified example 4, the magnetic disk device 1 calculates the inter-track difference values corresponding to each track after the maximum value of each track is measured, and determines whether the inter-track difference value of each track is greater than the inter-track threshold value for that track or equal to or less than the inter-track threshold value for that track. For that reason, the magnetic disk device 1 can simplify the refresh process.

In the embodiment and the modified embodiments described above, the magnetic disk device 1 manages the number of counts for each count area CR of each track. In addition, in some embodiments, the number of counts may be managed for each of multiple zones that are obtained by dividing the disk 10 into predetermined ranges in the radial direction (i.e., by dividing the tracks of the disk 10 into a plurality of zones that each include multiple tracks). In such embodiments, the magnetic disk device 1 tracks and/or stores a refresh threshold value for each such zone rather than for each track of the disk 10. The magnetic disk device 1 may be configured to execute the refresh process on a particular zone when it is determined that the number of counts of the particular zone is greater than the refresh threshold value of the particular zone.

While certain embodiments have been described, these embodiments have been presented by way of example only, and are not intended to limit the scope of the embodiments of the invention. Indeed, the novel embodiments described herein may be embodied in a variety of other forms; furthermore, various omissions, substitutions, and changes in the embodiments described herein may be made without departing from the spirit of the embodiments of the invention. The accompanying claims and their equivalents are intended to cover such forms or modifications as would fall within the scope and spirit of the embodiments of the invention.

What is claimed is:

1. A magnetic disk device comprising:
a disk with a plurality of data storage tracks;
a head that writes data to the plurality of data storage tracks and reads data from the plurality of data storage tracks; and
a controller configured to:
circumferentially divide each of the plurality of data storage tracks into multiple count areas,
for each count area in each of the plurality of data storage tracks, track a number of adjacent write counts,
determine that a first number of adjacent write counts for a first count area in a first data storage track causes a refresh threshold value for the first count area to be exceeded, and
in response to determining that the refresh threshold value has been exceeded, rewrite data stored in the first data storage track.

2. The magnetic disk device according to claim 1,
wherein the first number of adjacent write counts for the first count area indicates a number of times that data has been written to one or more count areas that are radially proximate to the first count area.

3. The magnetic disk device according to claim 2,
wherein the one or more count areas that are radially proximate to the first count area include at least one of a count area that is included in a different data storage track than the first data storage track and is radially adjacent to and contiguous with the first count area, and a count area that is included in a different data storage track than the first data storage track and is proximate the first count area in a radial direction of the disk.

4. The magnetic disk device according to claim 1,
wherein the controller is configured to rewrite the data stored in the first data storage track by:
reading the data stored in the first data storage track; and
after the reading, writing the read data to the first data storage track.

5. The magnetic disk device according to claim 1,
wherein the refresh threshold value for the first data count area is a threshold value for a largest number of adjacent write counts for the first data storage track,
wherein the largest number of adjacent write counts is the largest number of adjacent write counts among the numbers of adjacent write counts respectively tracked for the count areas in the first data storage track.

6. The magnetic disk device according to claim 1,
wherein the refresh threshold value for the first data storage track is a threshold value for an intra-track difference value for the first data storage track, and
wherein the intra-track difference value for the first data storage track is based on a difference between a largest number of adjacent write counts among the numbers of adjacent write counts respectively tracked for the count areas in the first data storage track and a smallest number of adjacent write counts among the numbers of adjacent write counts respectively tracked for the count areas in the first data storage track.

7. The magnetic disk device according to claim 1,
wherein the refresh threshold value for the first data storage track is a threshold value for an inter-track difference value for the first data storage track, and
wherein the inter-track difference value for the first data storage track is based on a difference between a largest number of adjacent write counts among the numbers of adjacent write counts respectively tracked for the count areas in the first data storage track and a largest number of adjacent write counts among the numbers of adjacent write counts respectively tracked for the count areas in a second data storage track that is radially proximate to the first data storage track.

8. The magnetic disk device according to claim 7, wherein the second data storage track is radially adjacent to the first data storage track.

9. The magnetic disk device according to claim 1,
wherein the refresh threshold value for the first data storage track is a threshold value for an inter-track difference value for the first data storage track, and
wherein the inter-track difference value for the first data storage track is based on a difference between the first number of adjacent write counts and a second number of adjacent write counts for a second count area that is radially proximate the first count area and is in a second data storage track radially adjacent to the first data storage track.

10. The magnetic disk device according to claim 1,
wherein the controller is further configured to determine that the first number of adjacent write counts causes the refresh threshold value for the first data storage track to be exceeded in response to data being written in a second data storage track radially proximate to the first data storage track.

11. The magnetic disk device according to claim 1, wherein the refresh threshold value for the first data storage track has a first value when the first data storage track is disposed in an inner radial area of the disk, a second value when the first data storage track is disposed in an outer radial area of the disk, and a third value when the first data storage track is disposed in an intermediate radial area.

12. The magnetic disk device according to claim 11,
wherein the first value and the third value are each less than the second value.

13. The magnetic disk device according to claim 1, wherein the first count area includes at least one sector of the first data storage track.

14. The magnetic disk device according to claim 1,
wherein the controller is further configured to, in response to data being written in a second count area that is in a second data storage track and is radially proximate to the first count area, increment the first number of adjacent write counts for the first count area.

15. A magnetic disk device comprising:
a disk with a plurality of data storage tracks;
a head that writes data to the plurality of data storage tracks and reads data from the plurality of data storage tracks; and
a controller configured to:
circumferentially divide each of the plurality of data storage tracks into multiple count areas,
for each count area in each of the plurality of data storage tracks, track a number of adjacent write counts,
determine that a first number of adjacent write counts for a first count area in a first data storage track causes a first refresh threshold value for the first count area to be exceeded and a second refresh threshold value for the first count area to be exceeded, and
in response to determining that both the first and second refresh threshold values have been exceeded, rewrite data stored in the first data storage track.

16. The magnetic disk device according to claim 15,
wherein the first refresh threshold value is one of a first threshold value, a second threshold value, or a third threshold value, and the second refresh threshold value is another of the first threshold value, the second threshold value, or the third threshold value,
wherein the first threshold value is a threshold value for a largest number of adjacent write counts among the numbers of adjacent write counts respectively tracked for the count areas in the first data storage track,
wherein the second threshold value is a threshold value for an intra-track difference value for the first data storage track, and
wherein the third threshold value is a threshold value for an inter-track difference value for the first data storage track.

17. The magnetic disk device according to claim 16,
wherein the inter-track difference value for the first data storage track is based on a difference between a largest number of adjacent write counts among the numbers of adjacent write counts respectively tracked for the count areas in the first data storage track and a largest number of adjacent write counts among the numbers of adjacent write counts respectively tracked for the count areas in a second data storage track that is radially proximate the first data storage track.

18. The magnetic disk device according to claim 16,
wherein the inter-track difference value for the first data storage track is based on a difference between the first number of adjacent write counts and a second number of adjacent write counts for a second count area that is radially proximate the first count area and is in a second data storage track adjacent to the first data storage track.

19. The magnetic disk device according to claim 16,
wherein the intra-track difference value for the first data storage track is based on a difference between a largest number of adjacent write counts among the numbers of adjacent write counts respectively tracked for the count areas in the first data storage track and a smallest number of adjacent write counts among the numbers of adjacent write counts respectively tracked for the count areas in the first data storage track.

20. A refresh processing method applied to a magnetic disk device with a disk that includes a plurality of data storage tracks and a head that writes data to the plurality of data storage tracks and reads data from the plurality of data storage tracks, the method comprising:
circumferentially dividing each of the plurality of data storage tracks into multiple count areas;
for each count area in each of the plurality of data storage tracks, tracking a number of adjacent write counts;
determining that a first number of adjacent write counts for a first count area in a first data storage track causes a refresh threshold value for the first count area to be exceeded; and
in response to determining the refresh threshold value has been exceeded, rewriting data stored in the first data storage track.
